(19) United States
(12) Patent Application Publication
(10) Pub. No.: US 2003/0035060 A1
(43) Pub. Date: Feb. 20, 2003

(54) Photo-taking apparatus with laser positioning means

(76) Inventors: Pai Chuan Yueh, Tao Yuan Hsien (TW); Ming-Jen Hsu, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/928,330

(22) Filed: Aug. 14, 2001

(51) Int. Cl. H04N 5/235

(52) U.S. Cl. 348/367; 348/370

(57) ABSTRACT

A photo-taking apparatus includes a control switch, a laser module controlled by the control switch to generate a laser beam for producing a light frame around the field to be photographed, a shutter controlled by the control switch means to expose a film to the light of the view of the field to be photographed, and a processor controlled by the control switch means to control the operation of the laser module and the shutter for producing a light frame and taking photos.

### BACKGROUND OF THE INVENTION

The present invention relates to photo-taking apparatus and, more particularly, to a photo-taking apparatus with laser positioning means, which can be controlled to produce a light frame to aim the lens at the object to be photographed.

When taking photos with a camera, the user has to aim the viewfinder eyepiece at the object to be photographed and to focus the lens on the object to be photographed. In certain conditions, for example, when in a crowded area or in the dark, it is not allowed to aim the viewfinder eyepiece at the object to be photographed. Currently, advanced cameras (digital cameras) are commonly equipped with a TFT-LCD for displaying the view of the object to be photographed. By means of the TFT-LCD, the user needs not to view the object through the viewfinder eyepiece when taking photos. However, these advances cameras are commonly expensive, not everybody can afford.

### SUMMARY OF THE INVENTION

The present invention has been accomplished under the circumstances in view. It is one object of the present invention to provide a camera, which uses a laser module to emit a laser beam for producing a light frame around the object to be photographed, so that the user can accurately aim the camera at the object without viewing through the viewfinder eyepiece. It is another object of the present invention to provide a light frame generating means for view finding, which is suitable for use in any of a variety of photo-taking apparatus including digital cameras, video cameras, digital video cameras, and video cameras. According to the present invention, the photo-taking apparatus comprises a control switch, a laser module controlled by the control switch means to generate a laser beam for producing a light frame around the field to be photographed, a shutter controlled by the control switch means to expose a film to the light of the view of the field to be photographed, and a processor controlled by the control switch to control the operation of the laser module and the shutter for producing a light frame and taking photos.

### BRIEF DESCRIPTION OF THE DRAWINGS

FIG. 1 is an elevational view of a camera with laser positioning means constructed according to the present invention.

FIG. 2 illustrates the internal structure of the camera with laser positioning means shown in FIG. 1.

FIG. 3 is a circuit block diagram of a camera with laser positioning means according to the present invention.

FIG. 4 is a circuit diagram of a digital camera with laser positioning means according to the present invention.

### DETAILED DESCRIPTION OF THE PREFERRED EMBODIMENT

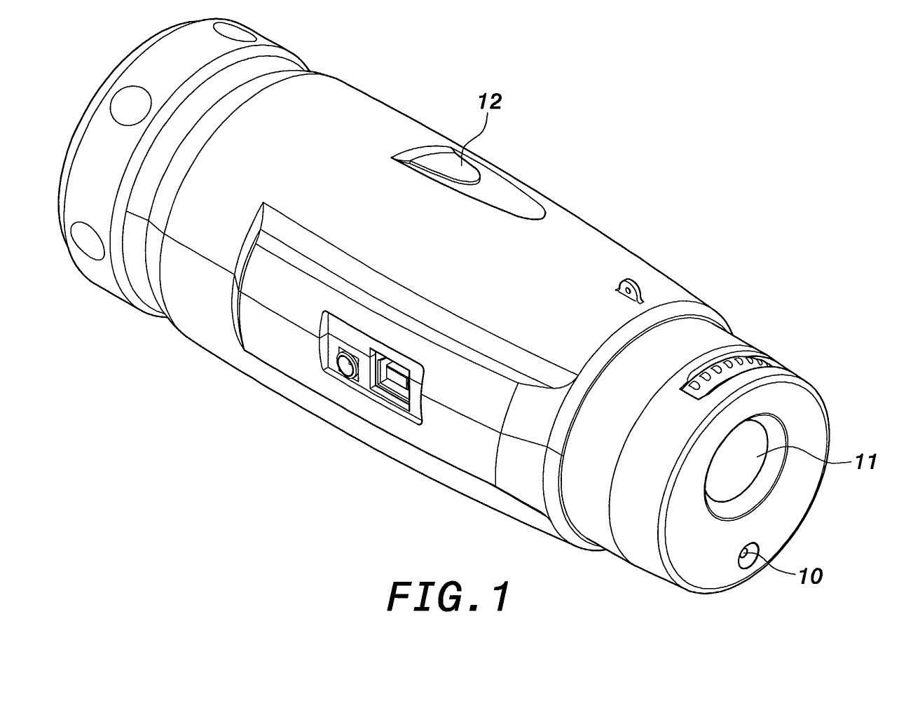

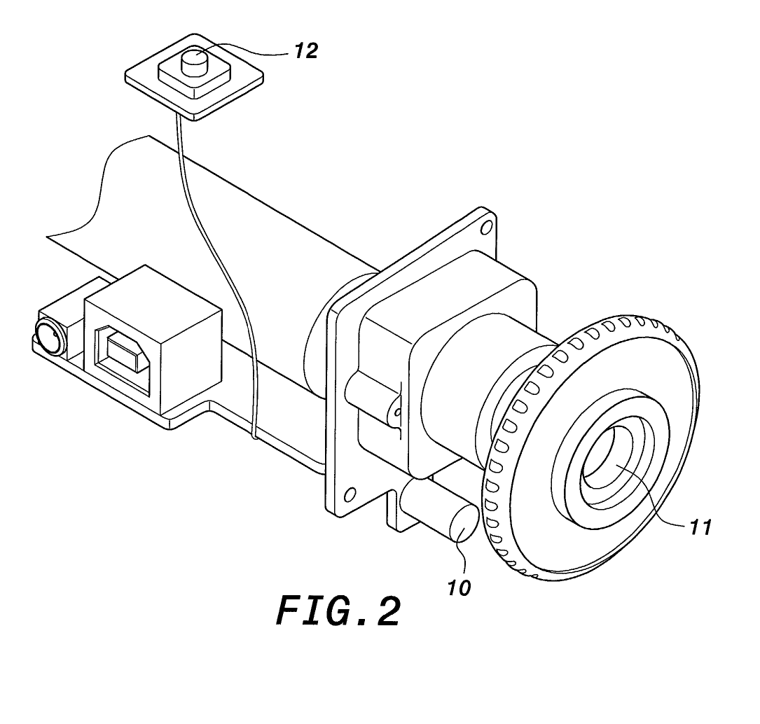

Referring to FIGS. 1 and 2, a photo-taking apparatus with laser positioning means in accordance with the present invention comprises a laser-generating device 10 disposed below the lens 11 thereof, and a two-step press-button control switch 12 adapted to control the shutter and the laser-generating device 10. When pressing the two-step press-button control switch 12, the laser-generating device 10 is driven to emit a laser beam, causing a light frame to be produced around the object to be photographed. When pressing the two-step press-button control switch 12 at the second time, the laser-generating device 10 is turned off and at the same time, the shutter is released to expose the film to the light of the view of the object to be photographed.

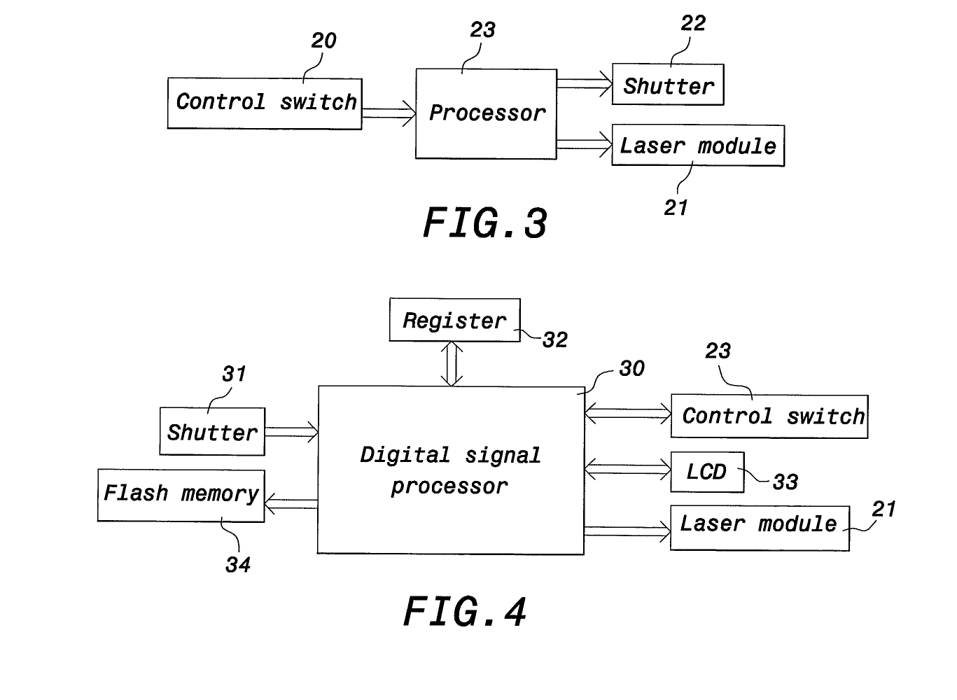

Referring to FIG. 3, the circuit of the present invention is comprised of a control switch 20, a laser module 21, a shutter 22, and a processor 23. The laser module 21 is equivalent to the aforesaid laser-generating device 10, and adapted to emit a laser beam for producing a light frame, i.e., the laser beam of the laser module 21 produces multiple light spots, forming a light frame surrounding the object to be photographed. Thus, the photo taken is the view of the object within the light frame. The light frame can be as small as for focusing the lens. The shutter 22 is a device adapted to expose a film to the light of the view of the object to be photographed. The control switch 20 is equivalent to the aforesaid two-step press-button control switch 12, and adapted to control the shutter 22 and the laser module 21. When pressing the control switch 20, the laser module 21 is driven to emit a laser beam, causing a light frame to be produced around the object to be photographed. When pressing the control switch 12 at the second time, the laser module 21 is turned off and at the same time, the shutter 22 is released to expose the film to the light of the view of the object to be photographed. As an alternate form of the present invention, laser module control switch and shutter control switch may be separately provided. Further, the photo-taking apparatus can be a digital camera, video camera, digital video camera, or video camera.

FIG. 4 is a circuit block diagram of a digital camera embodying the present invention. The digital camera uses a DSP (digital signal processor) 30 to process image signal. Image signal obtained through the shutter 31 is transmitted to the DSP 30 and then processed by the DSP 30 into digital signal, and the digital signal is then stored in the register 34 and displayed on the LCD 33. By means of controlling the DSP 30, obtained digital signal can be stored in the flash memory 34 readable to a computer or flash memory driver. By means of the control switch 23, the DSP 30 controls the operation of the laser module 21 and the shutter 31.

As indicated above, a camera with laser positioning means according to the present invention provides the following features:

1. The invention uses a laser beam to produce a positioning frame around the selected field, so that the desired photo of the selected field can accurately be taken.

2. By means of the assistance of the light frame of the leaser beam, the user needs not to aim the viewfinder eyepiece at the object in the selected field when taking photos.

3. When taking photos, the user needs not to visually check the range of the view of the selected field through the LCD.

4. The circuit design is simple and impact, suitable for use in any of a variety of digital cameras, video cameras, digital video cameras, and video cameras.

A prototype of photo-taking apparatus with laser positioning means has been constructed with the features of FIGS. 1˜4. The camera with laser positioning means functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A photo-taking comprising:
a control switch;
a laser module adapted to generate a laser beam for producing a light frame around the object to be photographed;
a shutter adapted to expose a film to the light of the view of the object to be photographed; and
a processor electrically connected to said control switch, said laser module and said shutter to control the operation of said laser module and said shutter for producing a light frame and taking photos.

2. The photo-taking apparatus of claim 1 wherein said control switch means is a two-step press-button switch, which drives said laser module to emit a laser beam for producing a light frame around the object to be photographed when pressed at the first time, turns off said laser module and releases said shutters to expose the film to the light of the view of the object to be photographed when pressed at the second time.

3. The photo-taking apparatus of claim 1 wherein said control switch means comprises a first switch adapted to control the operation of said laser module, and a second switch adapted to control the operation of said shutter.

4. The photo-taking apparatus of claim 1, which is a single-lens reflex camera.

5. The photo-taking apparatus of claim 1, which is a digital camera.

6. The photo-taking apparatus of claim 1, which is a video camera.

7. The photo-taking apparatus of claim 1, which is a digital video camera.
